(19) United States
(12) Patent Application Publication
(10) Pub. No.: US 2025/0379371 A1
(43) Pub. Date: Dec. 11, 2025

(54) Assembly of Terminal and Sleeve

(71) Applicants: Tyco Electronics (Suzhou) Ltd., Suzhou City (CN); Tyco Electronics (Shanghai) Co., Ltd., Shanghai (CN)

(72) Inventors: Kai (Rik) Chen, Suzhou (CN); Feng (Charles) Wan, Shanghai (CN); Limin Gao, Suzhou (CN)

(73) Assignees: Tyco Electronics (Suzhou) Ltd., Suzhou City (CN); Tyco Electronics (Shanghai) Co., Ltd., Shanghai (CN)

(21) Appl. No.: 19/230,660

(22) Filed: Jun. 6, 2025

(30) Foreign Application Priority Data
Jun. 6, 2024 (CN) 202410733164.9

(51) Int. Cl. H01R 4/06; H01R 4/18

(52) U.S. Cl. CPC H01R 4/06; H01R 4/184

(57) ABSTRACT

An assembly includes a terminal and a sleeve. The terminal has a main part extending in an axial direction. The sleeve is assembled onto the main part. The main part is formed with a first anti-rotation structure. The sleeve is formed with a second anti-rotation structure. The first anti-rotation structure and the second anti-rotation structure cooperate with each other and prevent the sleeve from rotating around the main part.

### CROSS-REFERENCE TO RELATED APPLICATION

This application claims the benefit of the filing date under 35 U.S.C. § 119 (a)-(d) of Chinese Patent Applications No. CN 202410733164.9 filed on Jun. 6, 2024.

### FIELD OF THE INVENTION

Embodiments of the present disclosure relate to a technical field of an electrical connection, and in particular, to an assembly of a terminal and a sleeve.

### BACKGROUND OF THE INVENTION

With the continuous development of electrical connection technology, an in-mold assembly process of a female terminal with a sleeve has gradually become a trend due to its advantages such as high efficiency and stability. According to the assembly process, a main part of the terminal is inserted into the sleeve, and then a portion of a wall of the sleeve near a positioning hole is riveted into a positioning groove of the main part of the terminal, to achieve the fixation between the sleeve and the main part of the terminal.

In practice, the sleeve may rotate around an axial direction relative to the main part of the terminal in the process of assembling. That is, there will be a relative displacement between the sleeve and the main part of the terminal in a circumferential direction in the process of assembling, resulting in a positional misalignment between the positioning hole in the sleeve and the positioning groove of the main part of the terminal, which will cause damage to the main part of the terminal and the sleeve in the subsequent riveting operation, affecting the subsequent processing and appearance.

### SUMMARY OF THE INVENTION

An assembly includes a terminal and a sleeve. The terminal has a main part extending in an axial direction. The sleeve is assembled onto the main part. The main part is formed with a first anti-rotation structure. The sleeve is formed with a second anti-rotation structure. The first anti-rotation structure and the second anti-rotation structure cooperate with each other and prevent the sleeve from rotating around the main part.

### BRIEF DESCRIPTION OF DRAWINGS

The invention will now be described by way of example with reference to the accompanying figures, of which:

FIG. 1 is a perspective view of an assembly of a terminal and a sleeve according to an exemplary embodiment;

FIG. 2 is another perspective view of the assembly of FIG. 1;

FIG. 3 is a sectional view of the assembly of FIG. 1 taken along line A-A of FIG. 2;

FIG. 4 is a sectional view of the assembly of FIG. 1 taken along line B-B of FIG. 2; and

FIG. 5 is a sectional view of the assembly of FIG. 1 taken along line C-C of FIG. 2.

### DETAILED DESCRIPTION

The technical solution of the present disclosure is further specifically described below through embodiments and in combination with the accompanying drawings. In the specification, the same or similar reference signs denote the same or similar parts. The following description of embodiments of the present disclosure with reference to the accompanying drawings is intended to explain the general inventive concept of the present disclosure, and should not be construed as limiting the present disclosure.

In addition, in the following detailed descriptions, for ease of explanation, numerous specific details are set forth in order to provide a thorough understanding of embodiments of the present disclosure. However, it is obvious that one or more embodiments may be implemented without these specific details. In other instances, well-known structures and devices are illustrated schematically in order to simplify the drawing.

It should be noted that, the word “comprise” or “include” do not exclude other elements or steps, and the word “a” or “an” do not exclude more than a plurality. In addition, any reference numerals in the claims should not be interpreted as a limitation to the scope of the present disclosure.

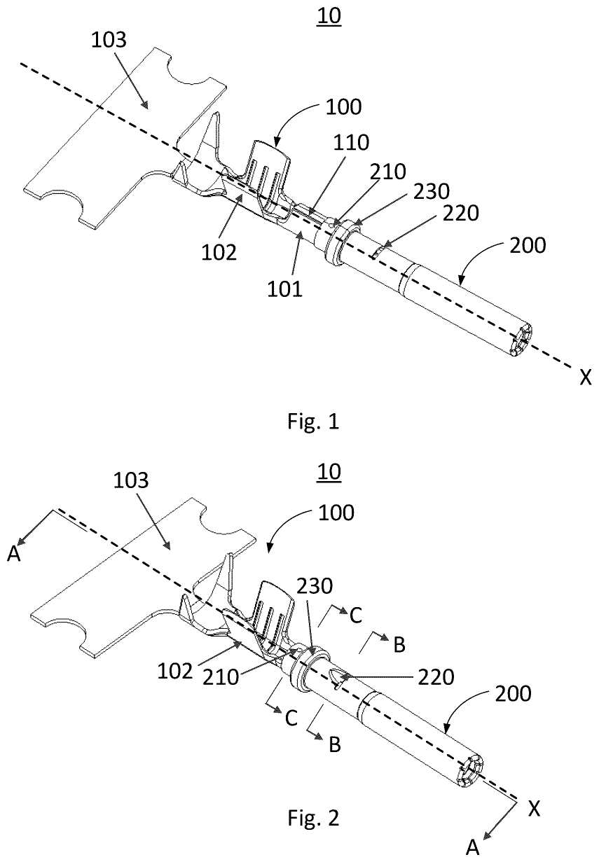

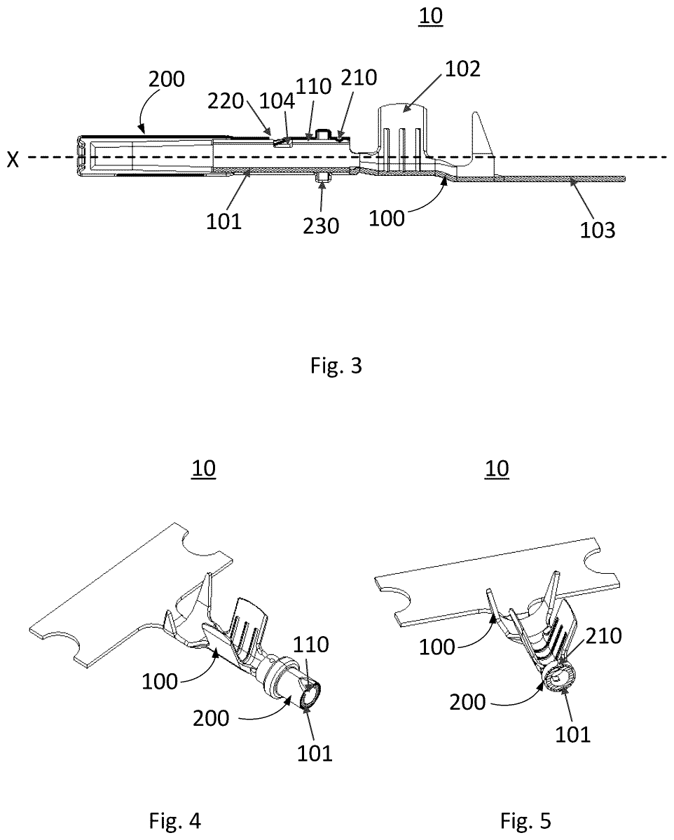

FIGS. 1-2 show a schematic perspective view of an assembly 10 of a terminal 100 and a sleeve 200 according to an exemplary embodiment of the present disclosure. FIG. 1 shows a structure of the assembly 10 of the terminal 100 and the sleeve 200 in the process of assembling the sleeve 200 onto a main part 101 of the terminal 100. FIG. 2 shows a structure of the assembly 10 of the terminal 100 and the sleeve 200 after assembling the sleeve 200 onto the main part 101 of the terminal 100. FIGS. 3-5 show schematic sectional views taken along lines A-A, B-B and C-C of FIG. 2, respectively.

As shown in FIGS. 1-5, according to the embodiments of the present disclosure, the assembly 10 of the terminal 100 and the sleeve 200 is adapted to an in-mold assembly process of a female terminal with a sleeve. As shown in FIGS. 1-5, the assembly 10 of the terminal 100 and the sleeve 200 includes a terminal 100 and a sleeve 200. The terminal 100 is made of a conductive metal sheet such as copper, and, as shown in FIGS. 1 and 3, includes a main part 101 extending in an axial direction X and a crimped part 102 adapted to receive a cable. The sleeve 200 is assembled onto the main part 101 of the terminal 100 in a sleeved manner.

According to the present disclosure, the main part 101 of the terminal 100 is formed with a first anti-rotation structure, and the sleeve 200 is formed with a second anti-rotation structure. In a process of assembling the sleeve 200 onto the main part 101 of the terminal 100, the first anti-rotation structure and the second anti-rotation structure cooperate with each other, to prevent the sleeve 200 from rotating around the main part 101. With the provision of the anti-rotation structure between the main part 101 of the terminal 100 and the sleeve 200, it is ensured that the main part 101 of the terminal 100 and the sleeve 200 maintain a stable relative position in the process of assembling, thereby avoiding the damage of the main part 101 of the terminal 100 and the sleeve 200 caused by the misalignment between the two, so as to improve the assembly efficiency and the product quality.

Specifically, according to the exemplary embodiments of the present disclosure, one of the first anti-rotation structure and the second anti-rotation structure is at least one guiding slot 110 extending in the axial direction X, as shown in FIGS. 1 and 3-4, and the other of the first anti-rotation structure and the second anti-rotation structure is at least one projection 210, as shown in FIGS. 1-3 and 5. The at least one projection 210 may be at least one protrusion, and the at least one guiding slot 110 may be at least one guiding groove.

In the process of assembling the sleeve 200 onto the main part 101 of the terminal 100, the at least one projection 210 travels in the at least one guiding slot 110, to prevent the sleeve 200 from rotating around the main part 101. In the exemplary embodiments shown in FIGS. 1-5, the first anti-rotation structure is at least one guiding slot 110 extending in the axial direction X, and the second anti-rotation structure is at least one projection 210. The guiding slot 110 is provided in an outer surface of the main part 101 of the terminal 100, and the projection 210 protrudes radially and inwardly from an inner surface of the sleeve 200. More specifically, in the exemplary embodiments shown in FIGS. 1-5, one guiding slot 110 is formed in the outer surface of the main part 101 of the terminal 100, and accordingly, one projection 210 is formed on the inner surface of the sleeve 200. However, in other embodiments, the guiding slot 110 may be formed in the inner surface of the sleeve 200, and the projection 210 protrudes radially and outwardly from the outer surface of the main part 101 of the terminal 100. In addition, in various other embodiments, the number of guiding slot 110 and projection 210 can be multiple depending on the specific size and manufacturability of the terminal 100.

The main part 101 of the terminal 100 is formed by winding a conductive metal sheet, and the guiding slot 110 is formed by chamfering two opposite edges of the conductive metal sheet forming the main part 101 of the terminal 100. The projection 210 is formed by recessing an inner surface of a wall of the sleeve 200 radially and inwardly. In this way, according to the present disclosure, the anti-rotation structure can be realized without the need to add additional materials, so that the anti-rotation structure can be realized without increasing the material cost, to improve the assembly quality. Of course, in other embodiments, based on actual needs, the manner in which the guiding slot 110 and/or the projection 210 may be formed may not be limited to this.

As shown in FIGS. 1 and 3, the guiding slot 110 and the projection 210 are matched in size and shape to ensure that the projection 210 can travel closely in the guiding slot 110 in the process of assembling the sleeve 200 onto the main part 101 of the terminal 100. In other words, the guiding slot 110 and the projection 210 are shaped complementary to each other. For example, the guiding slot 110 may have a shape of a linear groove with a U-shaped cross section or a V-shaped cross section, and the projection 210 may have a shape that matches the shape of the guiding slot, such as a convex hull.

Specifically, as shown in FIGS. 1 and 3, the guiding slot 110 extends from a first end (i.e., a part that is continuous with the crimped part 102) to an opposite second end of the main part 101 in the axial direction X. As shown in FIGS. 1-3, a riveting opening 220 is formed in the sleeve 200. After the sleeve 200 is assembled onto the main part 101 of the terminal 100, as shown in FIG. 2, a portion of the sleeve 200 near the riveting opening 220 is pressed radially and inwardly into an interior of the main part 101 and abuts against a positioning notch 104 of the main part 101 to limit a further displacement of the sleeve 200 relative to the main part 101 of the terminal 100. The positioning notch 104 may also be a positioning slot.

As shown in FIGS. 1-3, the terminal 100 further includes a handle 103. The crimped part 102 extends from the first end of the main part 101 in the axial direction X, and the handle 103 extends from the crimped part 102 in the opposite direction to the main part 101 along the axial direction X. The main part 101, the crimped part 102, and the handle 103 are integrally formed from a metal sheet.

As shown in FIGS. 1-3, the sleeve 200 is further formed with a projecting ring portion 230, which protrudes radially and outwardly from an outer surface of the sleeve 200. The projection 210 is located on one side of the projecting ring portion 230, and the riveting opening 220 is located on the opposite side of the projecting ring portion 230 in the axial direction X.

The assembly 10 of the terminal 100 and the sleeve 200 provided by the embodiments of the present disclosure ensures that the main part 101 of the terminal 100 and the sleeve 200 maintain a stable relative position in the process of assembling by providing the anti-rotation structure between the main part 101 of the terminal 100 and the sleeve 200, thereby avoiding the damage of the main part 101 of the terminal 100 and the sleeve 200 caused by the misalignment between the two, so as to improve the assembly efficiency and the product quality.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate the embodiments of the present disclosure by way of example, and should not be construed as limitation to the present disclosure.

Although some embodiments of the general inventive concept of the present disclosure have been shown and described, it would be appreciated by those skilled in the art that changes or modifications may be made to these embodiments without departing from the principles and spirit of the general inventive concept, the scope of which is defined in the claims and their equivalents.

1. An assembly, comprising:
a terminal having a main part extending in an axial direction; and
a sleeve assembled onto the main part, the main part is formed with a first anti-rotation structure and the sleeve is formed with a second anti-rotation structure, the first anti-rotation structure and the second anti-rotation structure cooperate with each other and prevent the sleeve from rotating around the main part.

2. The assembly of claim 1, wherein, one of the first anti-rotation structure and the second anti-rotation structure is at least one guiding slot extending in the axial direction, and the other of the first anti-rotation structure and the second anti-rotation structure is at least one projection, in a process of assembling the sleeve onto the main part, the at least one projection travels in the at least one guiding slot and prevents the sleeve from rotating around the main part.

3. The assembly of claim 1, wherein the first anti-rotation structure is at least one guiding slot extending in the axial direction, and the second anti-rotation structure is at least one projection, the at least one guiding slot is provided in an outer surface of the main part, and the at least one projection protrudes radially and inwardly from an inner surface of the sleeve.

4. The assembly of claim 3, wherein the at least one guiding slot is formed by chamfering an edge of the main part, and the at least one projection is formed by recessing the inner surface of the sleeve radially and inwardly.

5. The assembly of claim 3, wherein the at least one guiding slot and the at least one projection are shaped complementary to each other to ensure that the at least one projection travels closely in the at least one guiding slot in a process of assembling the sleeve onto the main part.

6. The assembly of claim 3, wherein the at least one guiding slot extends from a first end of the main part to an opposite second end of the main part in the axial direction.

7. The assembly of claim 1, wherein a riveting opening is formed in the sleeve, after the sleeve is assembled onto the main part, a portion of the sleeve near the riveting opening is pressed radially and inwardly into an interior of the main part and abuts against a positioning notch of the main part to limit a further displacement of the sleeve relative to the main part.

8. The assembly of claim 1, wherein the terminal has a crimped part receiving a cable, the crimped part extends from a first end of the main part in the axial direction.

9. The assembly of claim 8, wherein the terminal has a handle, the handle extends from the crimped part in a direction opposite to the main part along the axial direction.

10. The assembly of claim 9, wherein the main part, the crimped part, and the handle are integrally formed from a metal sheet.

11. The assembly of claim 1, wherein the sleeve is formed with a projecting ring portion, the projecting ring portion protrudes radially and outwardly from an outer surface of the sleeve.

12. The assembly of claim 7, wherein the sleeve is formed with a projecting ring portion, the projecting ring portion protrudes radially and outwardly from an outer surface of the sleeve, at least one projection of one of the first anti-rotation structure and the second anti-rotation structure is located on one side of the projecting ring portion and the riveting opening is located on the opposite side of the projecting ring portion in the axial direction.
